(19) United States
(12) Patent Application Publication
(10) Pub. No.: US 2015/0309975 A1
(43) Pub. Date: Oct. 29, 2015

(54) NON-TRANSITORY COMPUTER READABLE MEDIUM, INFORMATION PROCESSING APPARATUS, AND INFORMATION PROCESSING METHOD

(71) Applicant: FUJI XEROX CO., LTD., Tokyo (JP)

(72) Inventor: Toshifumi YAMADA, Kanagawa (JP)

(73) Assignee: FUJI XEROX CO., LTD., Tokyo (JP)

(21) Appl. No.: 14/665,165

(22) Filed: Mar. 23, 2015

(30) Foreign Application Priority Data
Apr. 28, 2014 (JP) 2014-092484

(51) Int. Cl. G06F 17/24

(52) U.S. Cl. CPC G06F 17/24; G06F 17/241

(57) ABSTRACT

A non-transitory computer readable medium stores a program causing a computer to execute a process for document-difference generation. The process includes estimating a range to be edited in target structured document information in response to a comment added to the target structured document information, based on a relationship between an element including a commented portion associated with the comment and another element of the target structured document information; and generating change-indicating information in which a difference within the estimated range between the target structured document information and structured document information obtained by editing the target structured document information is associated with the comment.

### CROSS-REFERENCE TO RELATED APPLICATIONS

This application is based on and claims priority under 35 USC 119 from Japanese Patent Application No. 2014-092484 filed Apr. 28, 2014.

### BACKGROUND

1. Technical Field

The present invention relates to a non-transitory computer readable medium, an information processing apparatus, and an information processing method.

2. Summary

According to an aspect of the invention, there is provided a non-transitory computer readable medium storing a program causing a computer to execute a process for document-difference generation. The process includes estimating a range to be edited in target structured document information in response to a comment added to the target structured document information, based on a relationship between an element including a commented portion associated with the comment and another element of the target structured document information; and generating change-indicating information in which a difference within the estimated range between the target structured document information and structured document information obtained by editing the target structured document information is associated with the comment.

### BRIEF DESCRIPTION OF THE DRAWINGS

Exemplary embodiments of the present invention will be described in detail based on the following figures, wherein:

FIG. 1 is a block diagram illustrating an example of a configuration of an information processing apparatus according to an exemplary embodiment;

FIGS. 2A and 2B are schematic diagrams illustrating an example of a configuration of Extensible Markup Language (XML) document information;

FIG. 3 is a schematic diagram illustrating an example of a configuration of XML document information to which a comment has been added;

FIG. 4 is a schematic diagram illustrating an example of a configuration of comment information;

FIG. 5 is a schematic diagram illustrating an example of XML document information;

FIG. 6 is a schematic diagram illustrating an example of an estimated range including a change (hereinafter, referred to as “possible change-including range”);

FIG. 7A is a schematic diagram illustrating an example of a configuration of difference information and FIG. 7B is a schematic diagram illustrating an example of a configuration of change-indicating information;

FIGS. 8A and 8B are schematic diagrams illustrating an example of how change-indicating information is displayed;

FIG. 9 is a flowchart illustrating an example of a comment information generation operation;

FIG. 10 is a flowchart illustrating an example of a change-indicating information generation operation;

FIG. 11 is a schematic diagram illustrating a possible change-including range according to a first modification;

FIG. 12 is a schematic diagram illustrating a possible change-including range according to a second modification;

FIG. 13 is a schematic diagram illustrating a possible change-including range according to a third modification;

FIG. 14 is a schematic diagram illustrating a possible change-including range according to a fourth modification;

FIG. 15 is a schematic diagram illustrating a possible change-including range according to a fifth modification; and

FIG. 16 is a schematic diagram illustrating a possible change-including range according to a sixth modification.

### DETAILED DESCRIPTION

### Exemplary Embodiment

### Configuration of Information Processing Apparatus

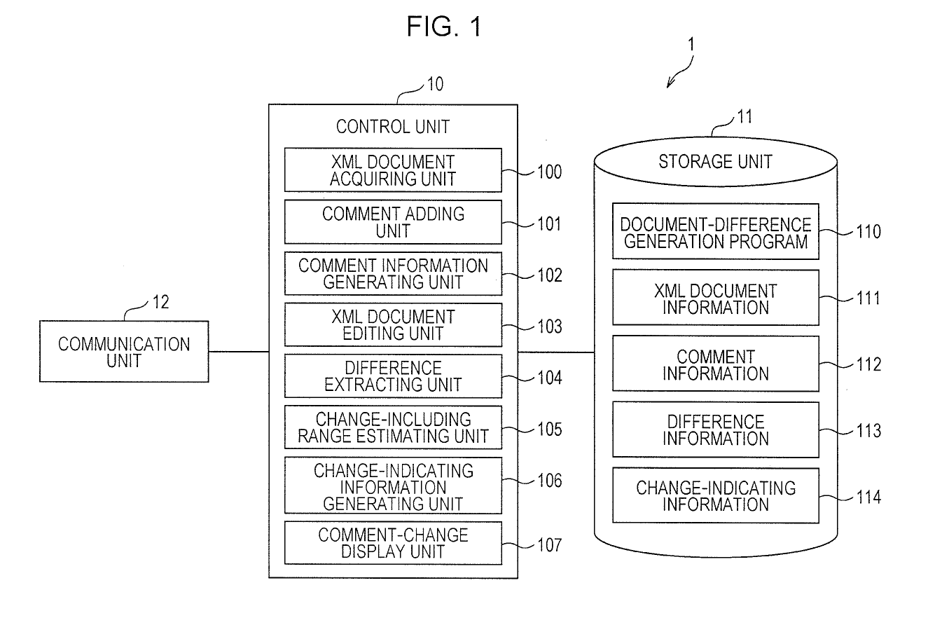

FIG. 1 is a block diagram illustrating an example of a configuration of an information processing apparatus according to an exemplary embodiment.

An information processing apparatus 1 handles structured document information, for example, Extensible Markup Language (XML) document information. The information processing apparatus 1 adds comment information which indicates a request for addition or modification to XML document information, in response to an operation performed by a first user and displays the XML document information including the comment information to a second user. The information processing apparatus 1 then creates a new version of the XML document information every time the XML document information is edited through an operation performed by the second user. The information processing apparatus 1 also generates difference information which indicates a difference between the multiple versions of XML document information that have been created. If the difference information has been generated in association with the comment information, the information processing apparatus 1 generates change-indicating information from the difference information and performs a display process. Through the display process, the information processing apparatus 1 presents a correspondence between the comment information and the change-indicating information.

It is assumed that the first and second users handle XML document information stored in the information processing apparatus 1 by operating external terminal apparatuses that are connected to the information processing apparatus 1 via a network.

The term “structured document” refers to a document in which plural elements form a tree structure, each of the plural elements including text and having a name such as “Topic” or “Title” for identification of a type of the element. In addition, the term “difference” encompasses at least a location of a difference portion, contents of a change, and version information of XML document information.

The information processing apparatus 1 includes a control unit 10, a storage unit 11, and a communication unit 12. The control unit 10 includes a central processing unit (CPU), controls individual units, and executes various programs. The storage unit 11 includes a storage medium such as a flash memory and stores information. The communication unit 12 communicates with an external apparatus via a network.

The control unit 10 executes a document-difference generation program 110 (described below) and consequently functions as an XML document acquiring unit 100, a comment adding unit 101, a comment information generating unit 102, an XML document editing unit 103, a difference extracting unit 104, a change-including range estimating unit 105, a change-indicating information generating unit 106, and a comment-change display unit 107, for example.

The XML document acquiring unit 100 acquires XML document information 111 to which comment information is to be added or which is to be edited.

The comment adding unit 101 adds a comment to the XML document information 111 in response to an operation performed by the first user.

The comment information generating unit 102 generates comment information 112 by associating the comment added by the comment adding unit 101 with the XML document information 111 and stores the comment information 112 in the storage unit 11.

The XML document editing unit 103 edits the XML document information 111 in response to an operation performed by the second user, creates a new version of the XML document information 111, and stores the new version of the XML document information 111 in the storage unit 11.

The difference extracting unit 104 compares the new version of the XML document information 111 created by the XML document editing unit 103 with the old (original) version of XML document information 111, extracts a difference therebetween, and stores the difference as difference information 113 in the storage unit 11.

The change-including range estimating unit 105 estimates a range to be edited in response to the comment from among elements of the XML document information 111 on the basis of the comment information 112.

The change-indicating information generating unit 106 generates change-indicating information 114 by extracting from the difference information 113 a difference corresponding to the range estimated by the change-including range estimating unit 105 and stores the change-indicating information 114 in the storage unit 11.

The comment-change display unit 107 performs a process for displaying the comment information 112 and the corresponding change-indicating information 114 on a display of a terminal apparatus used by the first user. Note that the comment information 112 and the change-indicating information 114 may be displayed on a display of a terminal apparatus used by the second user.

The storage unit 11 stores the document-difference generation program 110 which causes the control unit 10 to function as the XML document acquiring unit 100, the comment adding unit 101, the comment information generating unit 102, the XML document editing unit 103, the difference extracting unit 104, the change-including range estimating unit 105, the change-indicating information generating unit 106, and the comment-change display unit 107. The storage unit 11 also stores information such as the XML document information 111, the comment information 112, the difference information 113, and the change-indicating information 114.

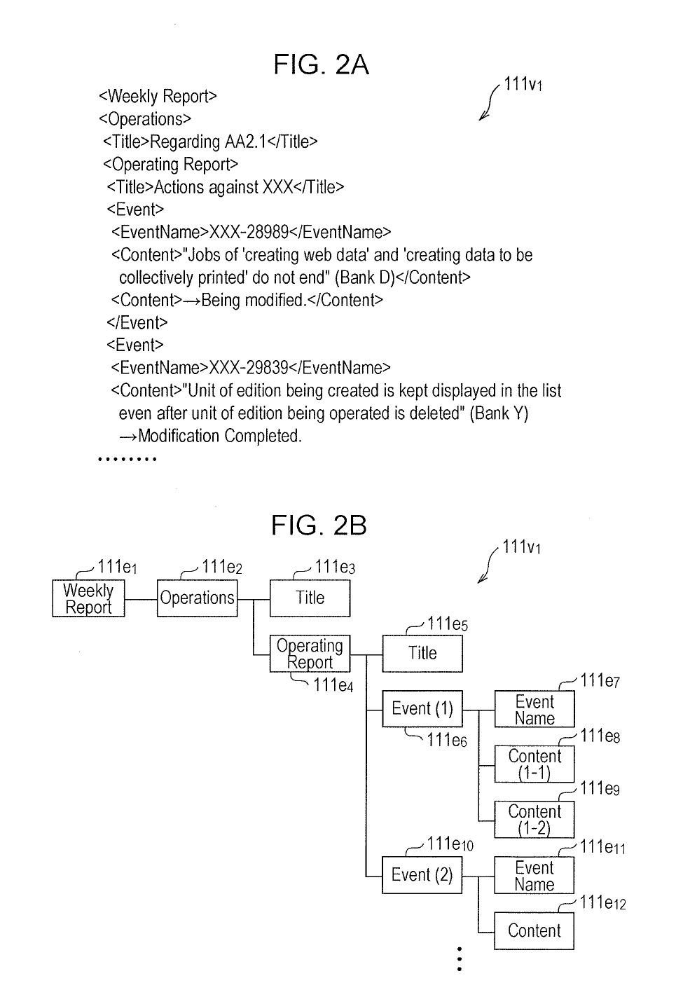

FIGS. 2A and 2B are schematic diagrams illustrating an example of a configuration of the XML document information 111.

FIG. 2A illustrates XML document information 111v₂ which represents a document of version 1 (i.e., the first version). A start tag “<XXX>”, an end tag “</XXX>”, and text placed between these tags form an element, and “XXX” placed between “<” and “>” represents the name of the element. In the case where one element includes a sub-element, the sub-element is called a child element of the one element. In the case where one element includes plural sub-elements, the plural sub-elements are called sibling elements.

FIG. 2B illustrates a tree structure of the XML document information 111v₂ by arranging child elements to the right and arranging sibling elements vertically. For example, an element 111e₂ having an element name “Operations” is a child element of an element 111e₁ having an element name “Weekly Report”. In addition, elements 111e₆ and 111e₁₀ respectively having element names “Event (1)” and “Event (2)” are sibling elements of an element. 111e₅ having an element name “Title”.

### Operations of Information Processing Apparatus

Now, operations according to the exemplary embodiment will be described in terms of (1) a comment information generation operation, (2) an editing operation, and (3) a change-indicating information generation operation.

### (1) Comment Information Generation Operation

The second user operates an external terminal apparatus, and the XML document information 111v₁ which is the initial version (i.e., the first version) is created as illustrated in FIG. 2A. The XML document information 111v₁ is stored in the storage unit 11.

Then, the first user operates an external terminal apparatus so as to send, to the information processing apparatus 1, a request for inputting a comment to the XML document information 111v₁.

Upon the information processing apparatus 1 accepting the comment input request, the XML document acquiring unit 100 acquires the XML document information 111v₁. Content of the acquired XML document information 111v₁ is displayed on a display of the external terminal apparatus operated by the first user.

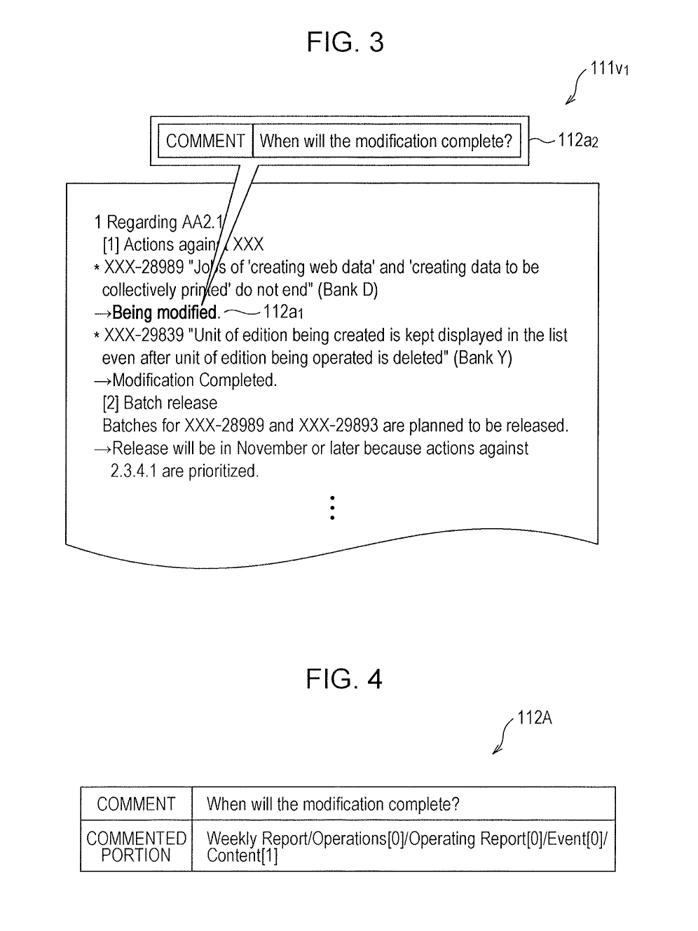

The first user then operates the external terminal apparatus so as to input a comment indicating a request for addition or modification as illustrated in FIG. 3 (described below).

FIG. 3 is a schematic diagram illustrating an example of a configuration of the XML document information 111v₂ to which a comment has been added.

For example, in the XML document information 111v₂, a comment 112a₂ “When will the modification complete?” is added by the first user at a commented portion 112a₁ for text “Being modified”.

The comment adding unit 101 of the information processing apparatus 1 adds the comment 112a₂ at the commented portion 112a₁ in the XML document information 111v₁.

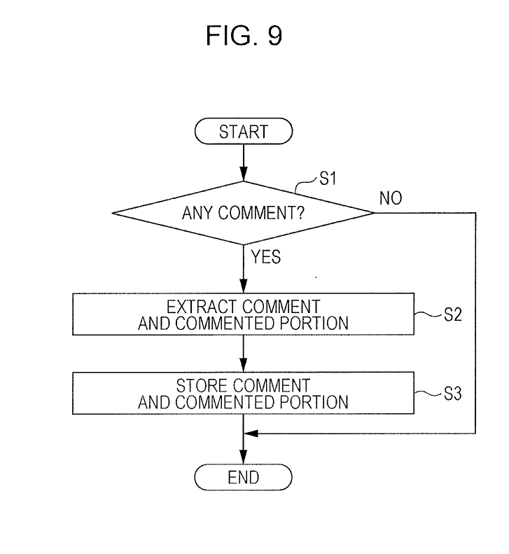

FIG. 9 is a flowchart illustrating an example of the comment information generation operation.

The comment information generating unit 102 checks the content of the XML document information 111v₁. Upon finding the comment 112a₂ (YES in step S1), the comment information generating unit 102 extracts the comment 112a₂ and the commented portion 112a₁ (step S2) and stores them as comment information 112A (illustrated in FIG. 4) in the storage unit 11 (step S3).

FIG. 4 is a schematic diagram illustrating an example of a configuration of the comment information 112A.

The comment information 112A, which is an example of the comment information 112, includes a comment field storing “When will the modification complete?” and a commented portion field storing “Weekly Report/Operations[0]/Operating Report[0]/Event[0]/Content[1]”. Note that the commented portion is represented using element names. If there are plural elements having an identical element name, the order indicating the target element is written in square brackets ([ ]). Specifically, the commented portion is at the second element among elements having a name “Content” which are child elements of the first element among elements having a name “Event” which are child elements of the first element among elements having a name “Operating Report” which are child elements of the first element among elements having a name “Operations” of a document called “Weekly Report”. That is, the element corresponding to the commented portion is the element 111e₉ illustrated in FIG. 2B.

### (2) Editing Operation

Then, the second user operates the external terminal apparatus so as to send, to the information processing apparatus 1, a request for editing the XML document information 111v₁.

Upon the information processing apparatus 1 accepting the request for editing, the XML document acquiring unit 100 acquires the XML document information 111v₁. As illustrated in FIG. 3, the content of the acquired XML document information 111v₁ is displayed on a display of the external terminal apparatus operated by the second user along with the content of the comment information 112.

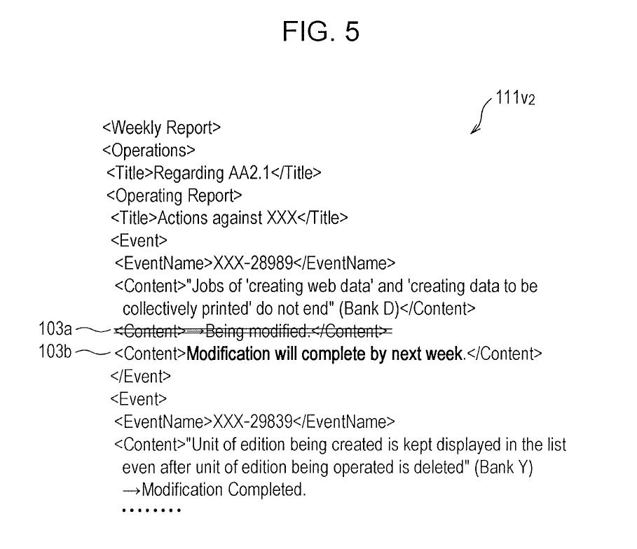

The second user operates the external terminal apparatus and edits the XML document information 111v₁ as illustrated in FIG. 5 (described below). In this way, XML document information 111v₂ is generated.

FIG. 5 is a schematic diagram illustrating an example of the XML document information 111v₂.

The XML document information 111v₂ is obtained by deleting an element 103a and adding an element 103b through an editing operation.

### (3) Change-Indicating Information Generation Operation

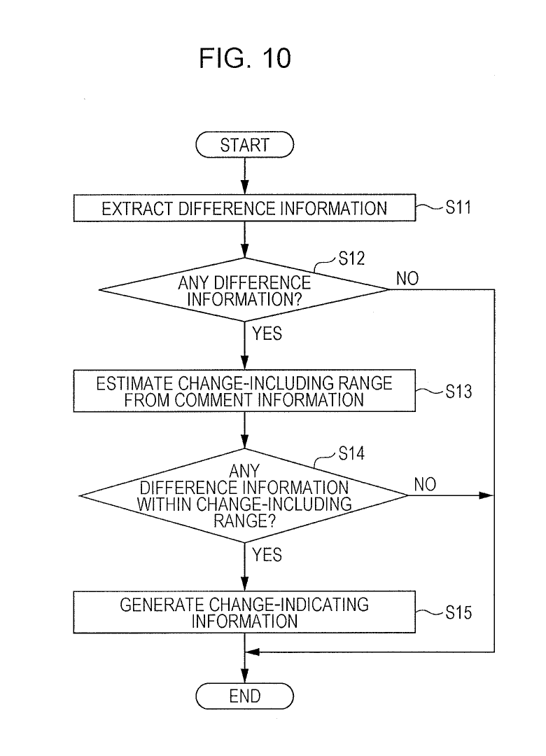

FIG. 10 is a flowchart illustrating an example of a change-indicating information generation operation.

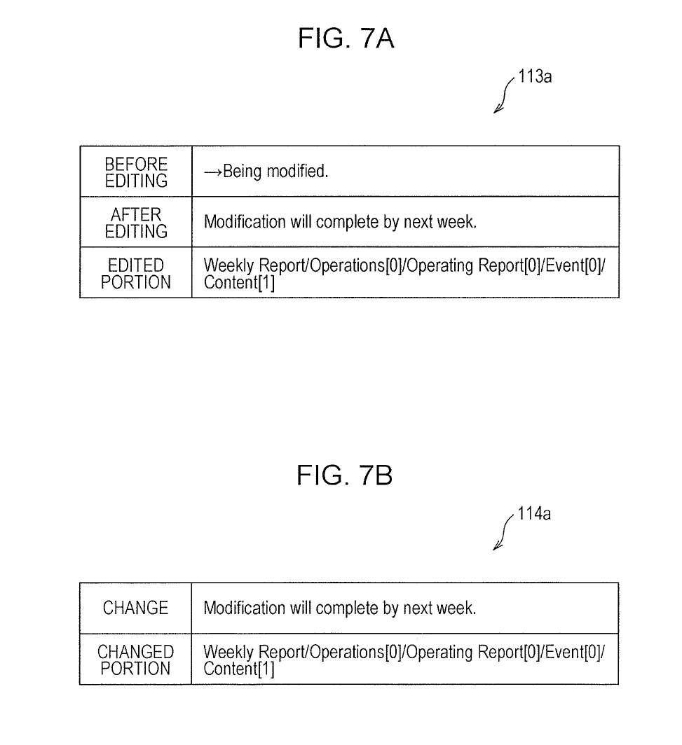

The XML document acquiring unit 100 of the information processing apparatus 1 acquires the XML document information 111v₂ generated by editing. The difference extracting unit 104 extracts a difference between the original XML document information 111v₁ and the XML document information 111v₂ and generates difference information 113a illustrated in FIG. 7A (described below) (step S11).

FIG. 7A is a schematic diagram illustrating an example of a configuration of the difference information 113a.

The difference information 113a, which is an example of the difference information 113, includes an edited portion field storing “Weekly Report/Operations[0]/Operating Report[0]/Event[0]/Content[1]”, a field storing text of the element before editing “→Being modified”, and a field storing text of the element after editing “Modification will complete by next week.”.

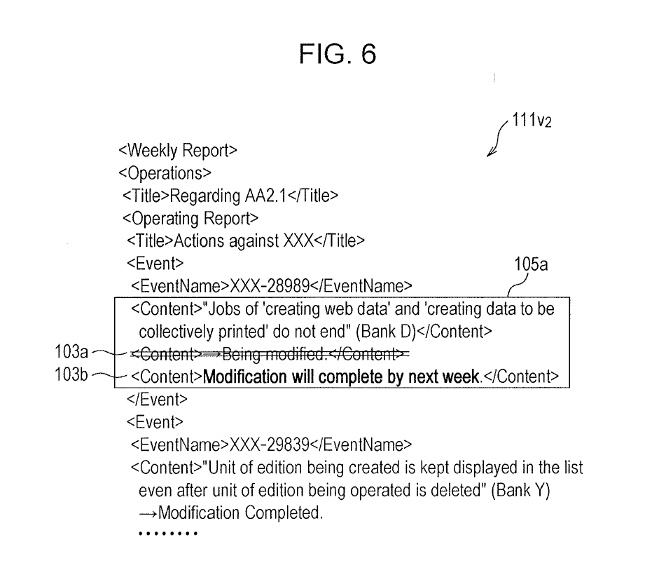

If there is the difference information 113a (YES in step S12), the change-including range estimating unit 105 estimates, based on the comment information 112A, as a possible change-including range 105a, a range of one or more elements to be edited in accordance with the comment information 112A as illustrated in FIG. 6 (described below) (step S13).

FIG. 6 is a schematic diagram illustrating an example of the possible change-including range 105a.

The possible change-including range 105a is a range estimated based on the comment information 112A. In the case where an element including the commented portion 112a₁ has a sibling element having a name identical to the name of the element, the element including the commented portion 112a₁ and the sibling element having the identical name form the possible change-including range 105a.

Specifically, as illustrated in FIG. 2B, the element 111e₉ includes the commented portion 112a₁. Accordingly, the element 111e₉ and the element 111e₈ which is a sibling element of the element 111e₉ and has an identical element name (“Content”) are estimated to form the possible change-including range 105a.

If there is the difference information 113a within the possible change-including range 105a (YES in step S14), the change-indicating information generating unit 106 generates change-indicating information 114a illustrated in FIG. 7B (described below) from the difference information 113a.

FIG. 7B is a schematic diagram illustrating an example of a configuration of the change-indicating information 114a.

The change-indicating information 114a includes as content of the change the text after editing included in the difference information 113a, and includes as a changed portion the edited portion within the possible change-including range 105a.

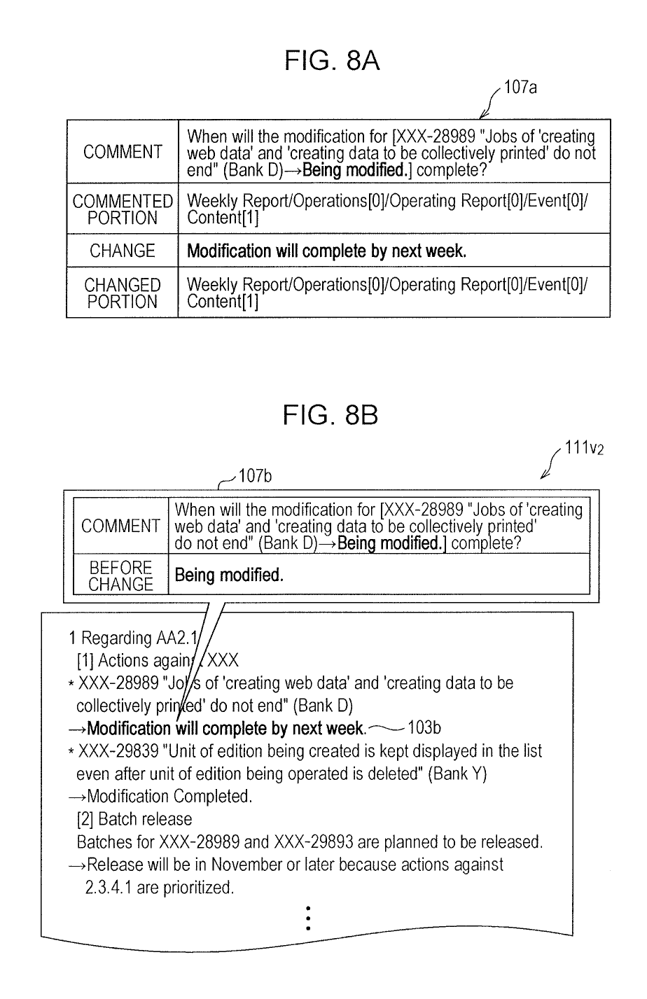

Then, the comment-change display unit 107 performs a display process on the comment information 112 and the change-indicating information 114 so as to display the comment information 112 and the change-indicating information 114 on a display of the external terminal apparatus as illustrated in FIG. 8A or 8B (described below).

FIGS. 8A and 8B are schematic diagrams illustrating an example of how the change-indicating information 114a is displayed.

As illustrated in FIG. 8A, the comment-change display unit 107 displays a comment-change display screen 107a in which the comment, the commented portion, the change, and the changed portion are associated with one another, for example.

Alternatively, as illustrated in FIG. 8B, the comment-change display unit 107 displays, along with the content of the XML document information 111v₂, a comment-change display image 107b in which the comment and the content of the element 103a before editing (FIG. 5) are associated with each other is displayed so as to point to the added element 103b.

In accordance with the exemplary embodiment described above, the possible change-including range 105a is estimated on the basis of the comment information 112, and the difference information 113 in the possible change-including range 105a is used as the change-indicating information 114.

First to sixth modifications described below illustrate modifications of a method for estimating the possible change-including range employed by the change-including range estimating unit 105.

### First Modification

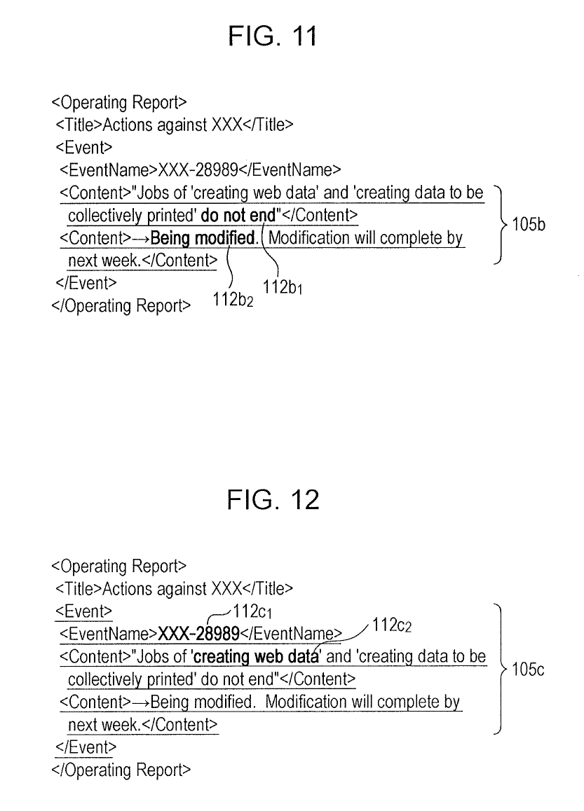

FIG. 11 is a schematic diagram illustrating a possible change-including range according to a first modification.

A possible change-including range 105b is a range estimated based on the comment information 112 which is different from that used in the above-described exemplary embodiment. In the case where a commented portion extends over plural elements just like commented portions 112b₁ and 112b₂ and the plural elements are sibling elements having the identical element name, these elements are estimated to form the possible change-including range 105b.

Specifically, the elements 111e₈ and 111e₉ respectively including the commented portions 112b₁ and 112b₂ are sibling elements having the identical element name “Content” as illustrated in FIG. 2B. Accordingly, the elements 111e₈ and 111e₉ are estimated to form the possible change-including range 105b. Note that if the elements 111e₈ and 111e₉ have another sibling element having the identical element name, such an element is also included in the possible change-including range 105b.

### Second Modification

FIG. 12 is a schematic diagram illustrating a possible change-including range according to a second modification.

A possible change-including range 105c is a range estimated based on the comment information 112 which is different from that used in the above-described exemplary embodiment. In the case where a commented portion extends over plural elements just like commented portions 112c₁ and 112c₂ and the plural elements are sibling elements having different element names, a range included in a parent element of these elements is estimated to form the possible change-including range 105c.

Specifically, the elements 111e₇ and 111e₈ respectively include the commented portions 112c₁ and 112c₂ and are sibling elements having different element names “EventName” and “Content”. Accordingly, a range included in the element 111e₆ which is a parent element of the elements 111e₇ and 111e₈, that is, a range from the element 111e₆ to the element 111e₉, is estimated to form the possible change-including range 105c.

### Third Modification

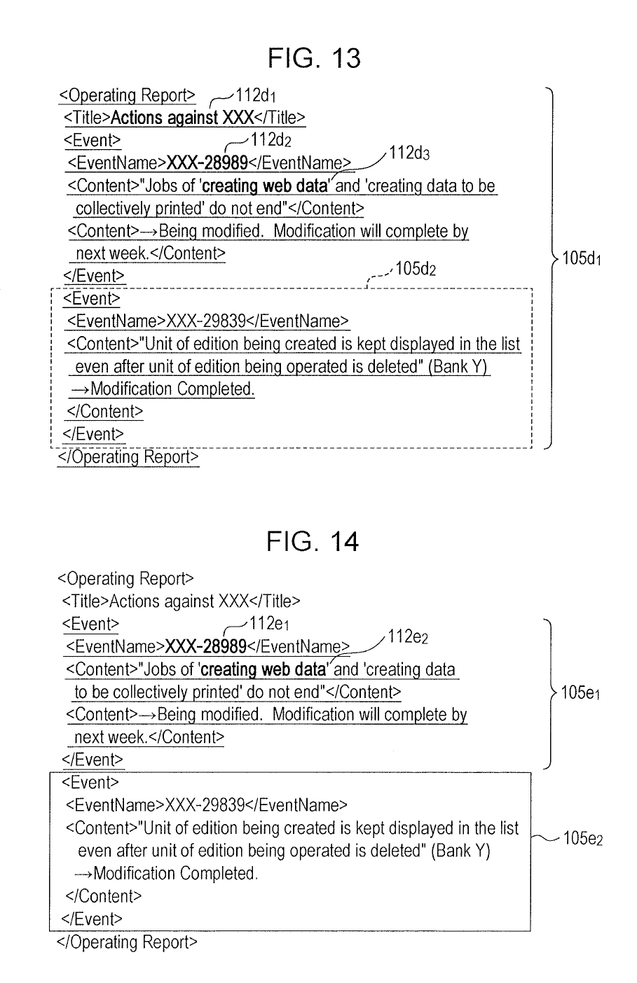

FIG. 13 is a schematic diagram illustrating a possible change-including range according to a third modification.

A possible change-including range 105d₁ excluding a range 105d₂ is a range estimated based on the comment information 112 which is different from that used in the above-described exemplary embodiment. As in the second modification described above, in the case where a commented portion extends over plural elements just like commented portions 111d₁, 112d₂, and 112d₃ and the plural elements are sibling elements having different element names, a range included in a parent element of these elements is estimated to form the possible change-including range 105d₁.

The element that includes the commented portions 112d₂ and 112d₃ and that has the element name “Event” is followed by a sibling element having the identical element name, and the following sibling element does not have any comment. Accordingly, the range 105d₂ corresponding to the following sibling element is excluded from the possible change-including range 105d₁.

Specifically, the elements 111e₅ and 111e₆ include the commented portions 112d₁, 112d₂, and 112d₃ and are sibling elements having different element names “Title” and “Event” as illustrated in FIG. 2B. Accordingly, a range included in the element 111e₄ which is a parent element of the elements 111e₅ and 111e₆, that is, a range from the element 111e₄ to the element 111e₁₀, is estimated to form the possible change-including range 105d₁. However, because the elements 111e₆ and the element 111e₁₀ are sibling elements having the identical element name, the range of the element 111e₁₀ is excluded from the possible change-including range 105d₁.

### Fourth Modification

FIG. 14 is a schematic diagram illustrating a possible change-including range according to a fourth embodiment.

Possible change-including ranges 105e₁ and 105e₂ are ranges estimated based on the comment information 112 which is different from that used in the above-described exemplary embodiment. As in the second modification described above, in the case where a commented portion extends over plural elements just like commented portions 112e₁ and 112e₂ and the plural elements are sibling elements having different element names, a range included in a parent element of these elements is estimated to form the possible change-including range 105e₁.

The element that includes the commented portions 112e₁ and 112e₂ and that has the element name “Event” is followed by a sibling element having the identical element name. Unlike the third modification, the possible change-including range 105e₂ is also estimated to form the possible change-including range along with the possible change-including range 105e₁.

Specifically, the elements 111e₇ and 111e₈ include the commented portions 112e₁ and 112e₂ and are sibling elements having different element names “EventName” and “Content” as illustrated in FIG. 2B. Accordingly, a range included in the element 111e₆ which is a parent element of the elements 111e₇ and 111e₈, that is, a range from the element 111e₆ to the element 111e₉, is estimated to form the possible change-including range 105e₁.

Further, because the elements 111e₆ and 111e₁₀ are sibling elements having the identical element name, a range of the element 111e₁₀ is estimated to form the possible change-including range 105e₂.

### Fifth Modification

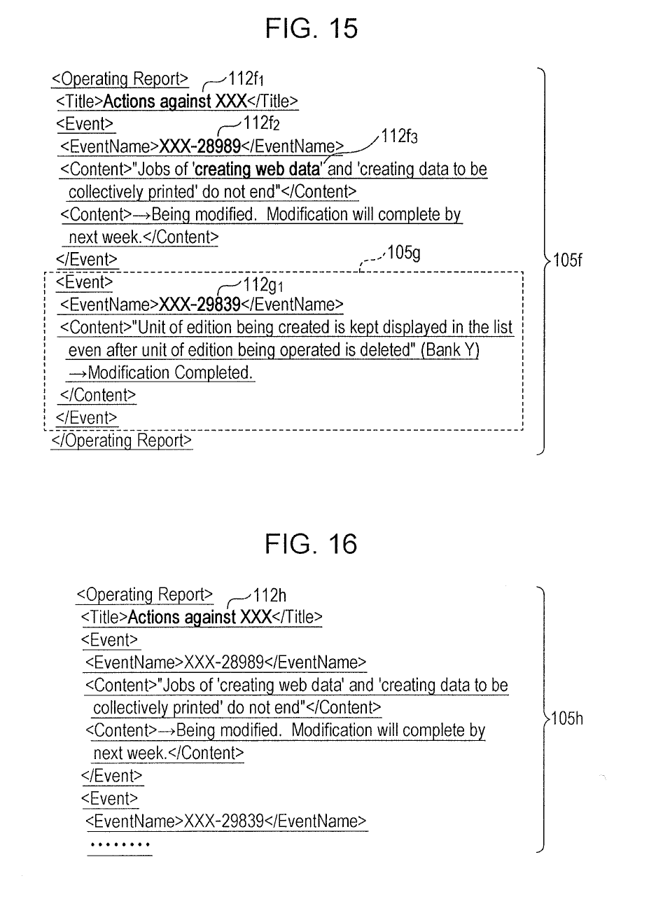

FIG. 15 is a schematic diagram illustrating a possible change-including range according to a fifth modification.

A possible change-including range 105f excluding a range 105g is a range estimated based on the comment information 112 which is different from that used in the above-described exemplary embodiment. As in the second modification described above, in the case where a commented portion extends over plural elements just like commented portions 112f₁, 112f₂, and 112f₃ and the plural elements are sibling elements having different element names, a range included in a parent element of these elements is estimated to form the possible change-including range 105f.

The element that includes the commented portions 112f₂ and 112f₃ and has the element name “Event” is followed by a sibling element that has the identical element name and the following sibling element includes a commented portion 112g₁ whose content is different from those of the commented portions 112f₂ and 112f₃. In such a case, the range 105g corresponding to the following sibling element having the identical element name is excluded from the possible change-including range 105f.

Specifically, the elements 111e₅ and 111e₆ include the commented portions 112f₁, 112f₂, and 112f₃ and are sibling elements having different element names “Title” and “Event” as illustrated in FIG. 2B. Accordingly, a range included in the element 111e₄ which is a parent element of the elements 111e₅ and 111e₆, that is, a range from the element 111e₄ to the element 111e₁₀, is estimated to form the possible change-including range 105f. However, because the elements 111e₆ and 111e₁₀ are sibling elements having the identical element name and the element 111e₁₀ includes the commented portion 112g₁ whose content is different from those of the commented portions 112f₁, 112f₂, and 112f₃, a range of the element 111e₁₀ is excluded from the possible change-including range 105f.

### Sixth Modification

FIG. 16 is a schematic diagram illustrating a possible change-including range according to a sixth modification.

A possible change-including range 105h is a range estimated based on the comment information 112 which is different from that used in the above-described exemplary embodiment. In the case where a comment is added only to an element indicating a heading just like a commented portion 112h, a range included in a parent element of the element indicating a heading is estimated to form the possible change-including range 105h. Specifically, in the case where the element 111e₃ which is an element indicating a heading includes the commented portion 112h as illustrated in FIG. 2B, a range included in the element 111e₂ which is a parent element of the element 111e₃, that is, a range from the element 111e₂ to the element 111e₁₂, is estimated to form the possible change-including range 105h.

### Other Exemplary Embodiments

The present invention is not limited to the exemplary embodiment described above and may be variously modified within the scope not departing from the gist of the present invention.

In the exemplary embodiment described above, the control unit 10 implements the functions of the XML document acquiring unit 100, the comment adding unit 101, the comment information generating unit 102, the XML document editing unit 103, the difference extracting unit 104, the change-including range estimating unit 105, the change-indicating information generating unit 106, and the comment-change display unit 107 by executing the document-difference generation program 110; however, all or some of these units may be implemented by hardware, such as an application specific integrated circuit (ASIC). In addition, the document-difference generation program 110 employed in the above-described exemplary embodiment may be provided after being stored on a recording medium, such as a compact disc read-only memory (CD-ROM). Changing the order of steps described in the exemplary embodiment and deleting or adding a step may be made within the scope not changing the gist of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for document-difference generation, the process comprising:
estimating a range to be edited in target structured document information in response to a comment added to the target structured document information, based on a relationship between an element including a commented portion associated with the comment and another element of the target structured document information; and
generating change-indicating information in which a difference within the estimated range between the target structured document information and structured document information obtained by editing the target structured document information is associated with the comment.

2. The non-transitory computer readable medium according to claim 1, wherein in a case where the element including the commented portion has a sibling element having a name identical to a name of the element, the element including the commented portion and the sibling element having the identical name are estimated to form the range.

3. The non-transitory computer readable medium according to claim 1, wherein in a case where the commented portion extends over a plurality of sibling elements having an identical name, the plurality of sibling elements having an identical name are estimated to form the range.

4. The non-transitory computer readable medium according to claim 1, wherein in a case where the commented portion extends over a plurality of sibling elements having different names, elements included in a parent element of the plurality of sibling elements having different names are estimated to form the range.

5. The non-transitory computer readable medium according to claim 4, wherein in a case where there are sibling elements having an identical name among the elements included in the parent element, an element not including the commented portion among the sibling elements having an identical name is excluded from the range.

6. The non-transitory computer readable medium according to claim 4, wherein in a case where the parent element has a sibling element having a name identical to a name of the parent element, the sibling element having the identical name is additionally estimated to form the range.

7. The non-transitory computer readable medium according to claim 4, wherein in a case where there are sibling elements having an identical name among the elements included in the parent element, an element including a commented portion different from the commented portion among the sibling elements having an identical name is excluded from the range.

8. The non-transitory computer readable medium according to claim 1, wherein in a case where an element indicating a heading includes the commented portion, one or more elements included in a parent element of the element indicating a heading are estimated to form the range.

9. The non-transitory computer readable medium according to claim 1, the process further comprising:
displaying information of the comment and the change-indicating information corresponding to the information of the comment.

10. An information processing apparatus comprising:
a change-including range estimating unit that estimates a range to be edited in target structured document information in response to a comment added to the target structured document information, based on a relationship between an element including a commented portion associated with the comment and another element of the target structured document information; and
a change-indicating information generating unit that generates change-indicating information in which a difference within the range estimated by the change-including range estimating unit between the target structured document information and structured document information obtained by editing the target structured document information is associated with the comment.

11. An information processing method comprising:
estimating a range to be edited in target structured document information in response to a comment added to the target structured document information, based on a relationship between an element including a commented portion associated with the comment and another element of the target structured document information; and
generating change-indicating information in which a difference within the estimated range between the target structured document information and structured document information obtained by editing the target structured document information is associated with the comment.
